(19) United States
(12) Patent Application Publication
(10) Pub. No.: US 2009/0073123 A1
(43) Pub. Date: Mar. 19, 2009

(54) Computer input device and method of manufacturing same

(75) Inventors: Guy Raz, Westlake Village, CA (US); Mike Simonian, San Francisco, CA (US); Maaike Evers, San Francisco, CA (US); Barry Sween, Santa Monica, CA (US)

Correspondence Address: BRYAN CAVE LLP, TWO NORTH CENTRAL AVENUE, SUITE 2200, PHOENIX, AZ, 85004, US

(73) Assignee: Belkin International, Inc., Compton, CA (US)

(21) Appl. No.: 11/903,244

(22) Filed: Sep. 18, 2007

(51) Int. Cl. G06F 3/033

(52) U.S. Cl. 345/166

(57) ABSTRACT

In one embodiment, a computer input device (100) includes: (a) an outer casing (110) with an interior cavity (360); (b) a scrolling mechanism (220) located within the interior cavity and useable through the outer casing; (c) one or more buttons (250) located within the interior cavity and useable through the outer casing; and (c) a movement mechanism (230) located within the interior cavity and configured to detect movement of the outer casing. The outer casing encloses the scrolling mechanism, the at least one button, and the movement sensor such that the computer input device is washable.

### FIELD OF THE INVENTION

This invention relates generally to an input device for a computer, and relates more particularly, to a computer mouse and methods of manufacturing the same.

### DESCRIPTION OF THE BACKGROUND

Computer input devices such as computer mice are ubiquitous in the home and the office. Many people including children handle these devices every day, and thus, a computer mouse can become dirty and unsanitary. For example, many people will operate a computer and use the mouse while eating or drinking. For example, food particles and other sticky substances can get stuck on or inside of the mouse. In other examples, a person may spill a drink on the mouse, or a child might handle a mouse with dirty fingers. An unclean computer mouse can present hygienic and safety issues and could even render the mouse permanently inoperable.

While soiling a mouse is easy, cleaning and disinfecting the mouse can be difficult. Most mice cannot be washed with water because contact with water can damage the electronics or housing of these sensitive devices.

Accordingly, a need exists for a computer input device that can be washed and disinfected without damaging the housing or the electronics inside the computer pointing device.

### BRIEF DESCRIPTION OF THE DRAWINGS

To facilitate further description of the embodiments, the following drawings are provided in which:

FIG. 1 illustrates a top, front, side isometric view of a computer input device, according to a first embodiment;

FIG. 2 illustrates a exploded view of the computer input device of FIG. 1, according to the first embodiment;

FIG. 3 illustrates a cross-sectional view along line 3-3 of FIG. 1 of the computer input device of FIG. 1, according to the first embodiment;

FIG. 4 illustrates a cross-sectional view along line 4-4 of FIG. 1 of the computer input device of FIG. 1, according to the first embodiment;

FIG. 5 illustrates a cross-sectional view along line 5-5 of FIG. 1 of the computer input device of FIG. 1, according to the first embodiment;

FIG. 6 illustrates a bottom view of the computer input device of FIG. 1, according to the first embodiment;

FIG. 7 illustrates a portion of a scrolling mechanism and an inner surface of an upper casing of computer input device of FIG. 1, according to the first embodiment;

FIG. 8 illustrates a top, front, side isometric view of a computer input device, according to a second embodiment;

FIG. 9 illustrates a top, front, side isometric view of a computer input device, according to a third embodiment;

FIG. 10 illustrates a cross-sectional view along line 10-10 of FIG. 9 of the computer input device of FIG. 9, according to the third embodiment; and

FIG. 11 illustrates a flow chart for a method of manufacturing a computer input device, according to an embodiment.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Furthermore, the terms “include,” and “have,” and any variations thereof, are intended to cover a non-exclusive inclusion, such that a process, method, system, article, or apparatus that comprises a list of elements is not necessarily limited to those elements, but may include other elements not expressly listed or inherent to such process, method, article, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein. The term “coupled,” as used herein, is defined as directly or indirectly connected in an electrical, physical, mechanical, or other manner. The term “on,” as used herein, is defined as on, at, or otherwise adjacent to or next to or over.

### DETAILED DESCRIPTION OF EXAMPLES OF EMBODIMENTS

In a number of embodiments, a computer input device can include: (a) an outer casing with an interior cavity; (b) a scrolling mechanism located within the interior cavity and useable through the outer casing; (c) one or more buttons located within the interior cavity and useable through the outer casing; and (d) a movement mechanism located within the interior cavity and configured to detect movement of the outer casing. In these embodiments, the outer casing encloses the scrolling mechanism, the at least one button, and the movement sensor such that the computer input device is washable.

In other embodiments, a mouse for a computer can include: (a) an outer casing with an interior cavity; (b) a touchpad located within the interior cavity and useable through the outer casing; (c) one or more buttons within the interior cavity and useable through the outer casing; and (d) a movement mechanism within the interior cavity and configured to detect movement of the outer casing. In these embodiments, the outer casing is configured to protect the touchpad, the one or more buttons, and the movement mechanism from running water at any angle and at a standard household water pressure.

In a further embodiment, a mouse includes: (a) a case having: (1) an upper casing with an inner surface; and (2) a lower casing with an inner surface and mechanically coupled to the upper casing to form a first waterproof seal; (b) at least one button located inside the case and adjacent to the inner surface of the upper casing; and (c) a movement sensor located inside the case and adjacent to the inner surface of the lower casing. In this embodiment, the at least one button and the scrolling mechanism are accessible by a user through the upper casing. Furthermore, the at least one button is separated from the inner surface of the upper casing by a gap.

In yet another embodiment, a method of manufacturing a computer input device can include: (a) providing an upper casing with an inner surface; (b) proving a lower casing with an inner surface; (c) providing at least one button; (d) positioning the at least one button under the inner surface of the upper casing; (e) providing a scrolling mechanism; (f) positioning the scrolling mechanism under the inner surface of the upper casing; (g) providing a movement sensor; (h) positioning the movement sensor above the inner surface of the lower casing; and (i) forming a waterproof seal between the upper casing and the lower casing such that the computer input device is washable and the at least one button, the scrolling mechanism, and the movement sensor are located in a cavity formed by the upper casing and the lower casing.

In still another embodiment, a computer mouse includes: (a) a case having an internal space and including: (1) a first portion with a first thickness; and (2) a second portion with a second thickness less than the first thickness; (b) a touchpad located within internal space and useable through the case; (c) at least one button located within the internal space and useable through the case; and (d) a movement mechanism located within the internal space and configured to detect movement of the case and including; (1) a sensor; (2) a sensor lens; and (3) a lens seal providing a waterproof seal between the sensor lens and the case. In this embodiments, the case protects the scrolling mechanism, the at least one button, and the movement sensor from running water at any angle and at a standard household water pressure. Furthermore, the at least one button is located adjacent to the first portion of the case and the touchpad is located adjacent to the second portion of the case.

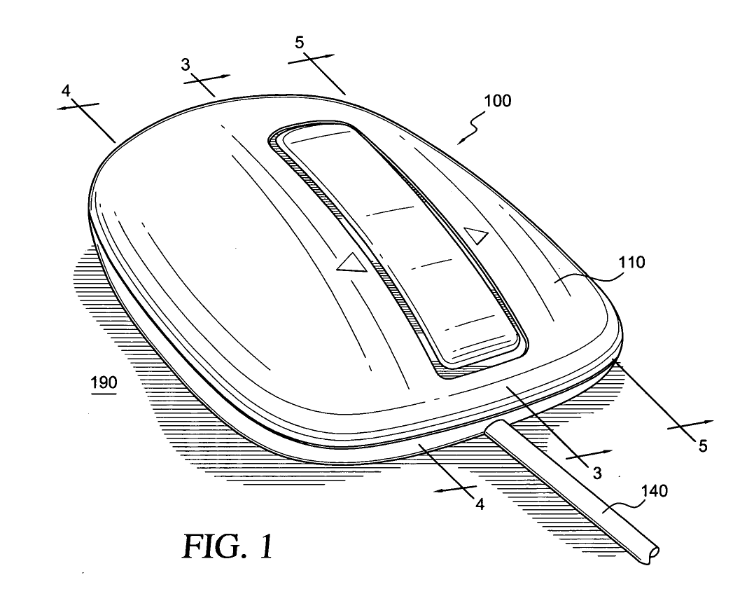

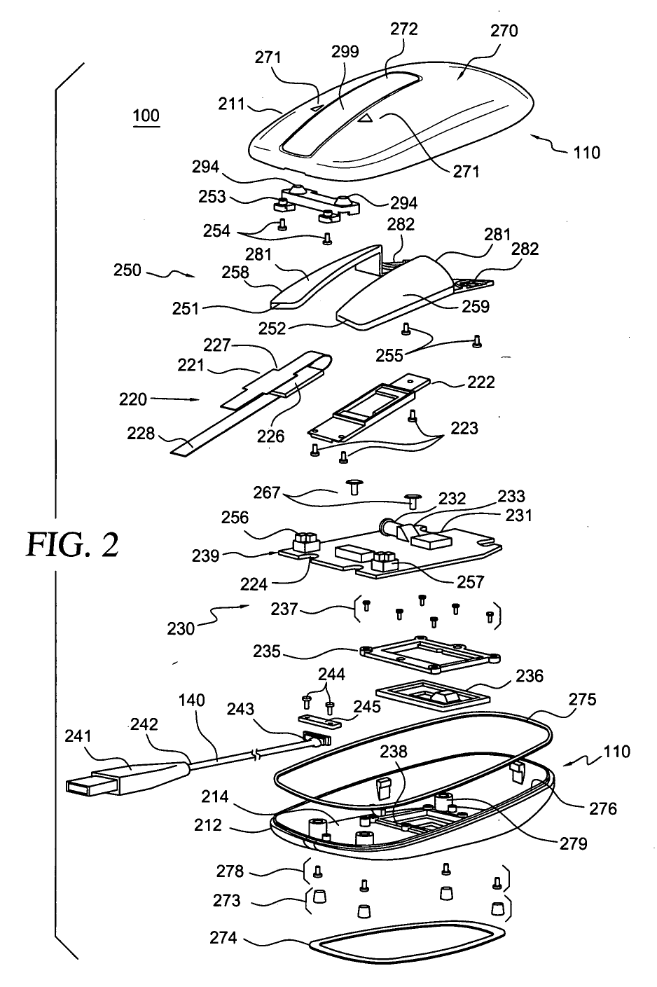

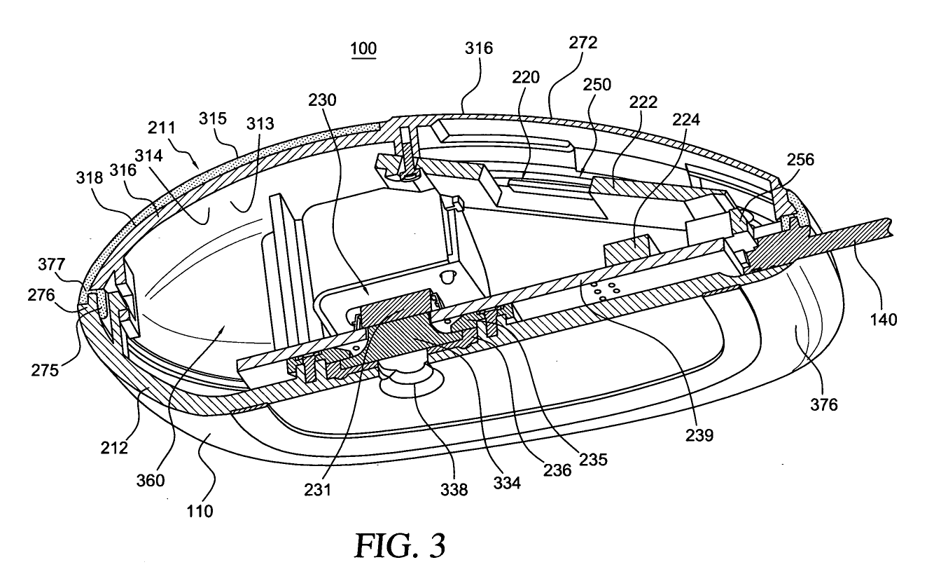

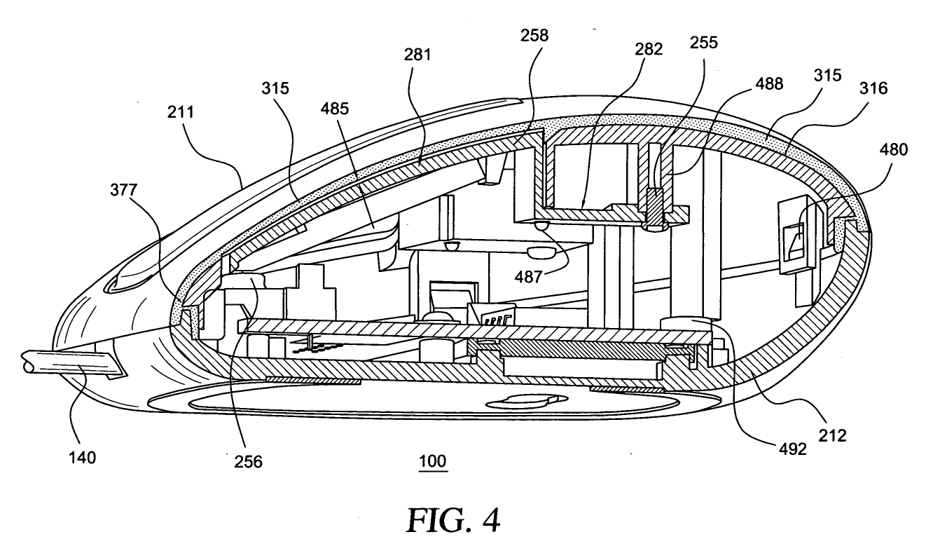

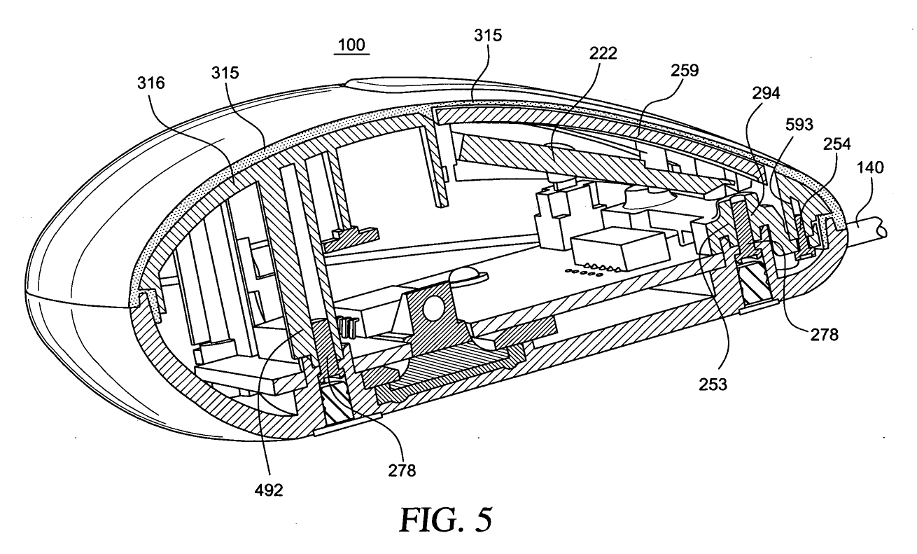

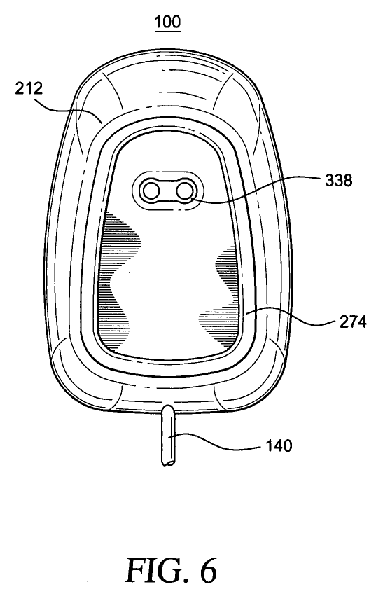

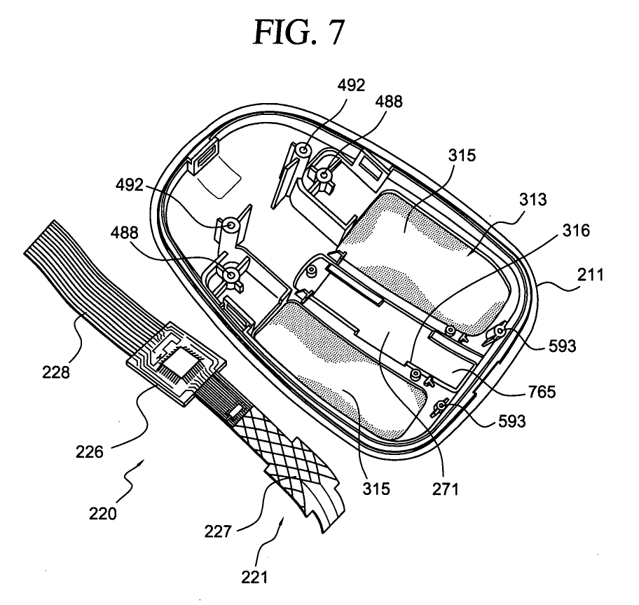

Turning to the drawings, FIG. 1 illustrates a top, front, side isometric view of a computer input device 100, according to a first embodiment. FIG. 2 illustrates an exploded view of computer input device 100, according to the first embodiment. FIG. 3 illustrates a cross-sectional view along line 3-3 (FIG. 1) of computer input device 100, according to the first embodiment. FIG. 4 illustrates a cross-sectional view along line 4-4 (FIG. 1) of computer input device 100, according to the first embodiment. FIG. 5 illustrates a cross-sectional view along line 5-5 (FIG. 1) of computer input device 100, according to the first embodiment. FIG. 6 illustrates a bottom view of computer input device 100, according to the first embodiment. FIG. 7 illustrates a portion of a scrolling mechanism 220 and an inner surface 313 of an upper casing 211 of computer input device 100, according to the first embodiment.

Computer input device 100 is merely exemplary and is not limited to the embodiments presented herein. Computer input device 100 can be employed in many different embodiments or examples not specifically depicted or described herein.

In the embodiment illustrated in FIGS. 1-7, a mouse or computer input device 100 includes: (a) a outer casing or case 110 with an interior cavity 360; (b) a scrolling mechanism 220 located within interior cavity 360; (c) a movement mechanism 230 located within interior cavity 360 and configured to detect movement of case 110; (d) one or more buttons 250 located within interior cavity 360; (e) a cable 140 with an end 242 and an end 243 opposite end 242; and (f) a connector 241 coupled to end 242. In this embodiment, scrolling mechanism 220, movement mechanism 230, and buttons 250 are accessible or useable by a user through case 110. Moreover, case 110 can enclose scrolling mechanism 220, movement mechanism 230, and buttons 250 such that computer input device 100 is waterproof or washable. In the same or a different embodiment, case 110 is configured to protect scrolling mechanism 220, movement mechanism 230, and buttons 250 from running water. Enclosing scrolling mechanism 220, movement mechanism 230, and buttons 250 inside of case 110 can allow a user to wash and disinfect computer input device 100 without damaging scrolling mechanism 220, movement mechanism 230, and buttons 250.

“Washable,” as used herein, can mean that the device can be placed under running water at any angle at standard household water pressure without damaging the device, and/or that the device can be splashed with water from any direction without the device suffering any harmful effects. Standard household water pressure can be water pressure between 100 and 830 kilopascal (kPa). In a preferred example, standard household water pressure is between 345 and 690 kPa. In one embodiment, a device is washable if the device complies with the International Electrotechnical Commission's IPX-4 (International Protection) international standard for water resistance. In a further embodiment, a device is washable if the device complies with International Electrotechnical Commission's IPX-5 (or higher) international standard for water resistance.

As used herein, when a device is described to be “washable,” it does not mean or imply that any connectors outside of the case or housing of the device are washable. Such connectors do not have to be washable for the device to be washable. For example, a device could be washable, even though it includes a non-washable and non-water resistant Universal Serial Bus (USB) connector.

In an example, case 110 can protect scrolling mechanism 220, movement mechanism 230, and buttons 250 from water sprayed from a nozzle with an internal diameter of 6.3 millimeters (mm) with a delivery rate of 12.5 liters per minute (l/min). In this example, the nozzle can be placed between 2.5 and 3.0 meters from case 110. In another example, case 110 provides protection when the delivery rate is 100 l/min.

Case 110 can include: (a) an upper casing 211 with an inner surface 313; and (b) a lower casing 212 with an inner surface 214 and an outer surface 376. In some embodiments, buttons 250 and scrolling mechanism 220 are adjacent to or contiguous with inner surface 313. Likewise, movement mechanism 230 can be adjacent to or contiguous with inner surface 214.

In the example illustrated in FIGS. 1-7, upper casing 211 is mechanically coupled to lower casing 212 to form a seal. In some examples, the seal can be a waterproof seal. Interior cavity 360 includes the interior space between lower casing 212 and upper casing 211 when upper casing 211 is coupled to lower casing 212.

In some embodiments, the seal can be formed by a gasket 275 and one or more screws 278. In these embodiments, lower casing 212 can further include one or more screw holes 279 and upper casing 211 can include one or more screw receptacles 492. Furthermore, a link 253 can be coupled to upper casing 211 to facilitate the coupling of upper casing 211 and lower casing 212. In some examples, link 253 is screwed into screw receptacles 593 in upper casing 211 using screws 254. Screws 278 can be screwed into screw receptacles 294 and 492 to form a pressure seal between upper casing 211 and lower casing 212. In some examples, gasket 275 can be inserted between the edges of upper casing 211 and lower casing 212 to help increase the effectiveness of the seal. Additionally, in various embodiments, a snap lock 480 can also be used to hold upper casing 211 to lower casing 212.

In the same or a different embodiment, upper casing 211 and lower casing 212 can also have a tongue and groove design to help create the waterproof seal. For example, upper casing 211 can include a groove 377, and lower casing 212 can include a tongue 276. In various examples, gasket 275 can be inserted between upper casing 211 and lower casing 212 adjacent to where groove 377 is coupled to tongue 276. In these examples, upper casing 211 mechanically couples to lower casing 212 by screwing lower casing 212 to upper casing 211 using screws 278 to create a pressure seal. Screws 278 can be inserted into lower casing 212 through screw holes 279 and screwed into screw receptacles 294 and 492. In some embodiments, one or more rubber or plastic plugs 273 can be glued into screw holes 279 after screws 278 are fastened within screw holes 279 to prevent the ingress of water through screw holes 279. After inserting plugs 273, a pad 274 can be coupled to the outer surface of lower casing 212 to: (a) hide screw holes 279; (b) allow easier movement of computer input device 100 across a surface; and/or (c) provide another seal to prevent water from entering case 110 through screw holes 279.

In some embodiments, upper casing 211 can be composed of various materials and have a varying thickness. For example, upper casing 211 can include: (a) a substrate 316 having an outer surface 318 and an inner surface 314 opposite outer surface 318; and (b) an overmold 315. Furthermore, in some examples, upper casing 211 can include: (a) a portion 272 composed of substrate 316 and devoid of overmold 315; (b) portion 270 composed of substrate 316 and overmold 315; and (c) a portion 271 composed of overmold 315 and devoid of substrate 316. In some examples, lower casing 212 is composed of a third material similar to or different from substrate 316 and overmold 315. In other embodiments, lower casing 212 is composed of the same material as substrate 316 with or without overmold 315.

Portion 272 can include the section of upper casing 211 located adjacent to and directly over scrolling mechanism 220. Portion 271 can include the sections of upper casing 211 adjacent to and directly over buttons 250. Portion 270 can include the sections of upper casing 211 not adjacent to buttons 250 or scrolling mechanism 220.

In some examples, the thickness of upper casing 211 can vary between portions 270, 271, and/or 272. For example, portion 270 can have a first thickness; portion 271 can have a second thickness; and portion 272 can have a third thickness. In one example, the first thickness can be less than the second thickness. Moreover, the third thickness can be less than the first thickness and the second thickness. For example, the first thickness can be 1.8 millimeters (mm), the second thickness can be 1.2 mm, and the third thickness can be 0.75 mm.

In some embodiments, the thickness of portions 270, 271, and 272 varies based on the functionality the components adjacent to each portion while providing a sturdy, rugged, sealed frame for computer input device 100. In one example, portion 271 can be thinner than portions 270 and 272 to allow easier depression of buttons 250. However, in some embodiments, thinning portion 271 to decrease the push force needed to depress buttons 250 is balanced with the desire to avoid creation of surface distortions on the outer surface of case 110. If portion 271 is made too thin and elastic, it can become distorted, and a permanent outline of the buttons might be created on the outer surface of case 110.

In the same or different example, scrolling mechanism 220 can be useable through portion 272. To facilitate use of scrolling mechanism 220, overmold 315 does not cover portion 272, and the thickness of substrate 316 can be decreased at portion 272.

Substrate 316, overmold 315, and lower casing 212 are preferably made of a material that: (a) balances the factors already discussed; (b) is tough, hard, water-resistant, and rigid; (c) has good chemical and oil resistance, and dimensional stability; (d) exhibits good creep resistance; and (e) is relatively strong and inexpensive. Accordingly, substrate 316, overmold 315, and lower casing 212 can be constructed of acrylonitrile butadiene styrene (ABS), polycarbonate, polypropylene, polyethylene, a copolyester elastomer (COPE), a thermoplastic polyurethane elastomer (TPU), a thermoplastic elastomer (TPE), or a similar material, all of which, to varying degrees, exhibit the stated properties. In one example, substrate 316 is polycarbonate, overmold 315 is a TPU, and lower casing 212 is ABS. In other embodiments, substrate 316 and lower casing 212 can be composed of the same material. In one embodiment, the same material is used in substrate 316 and lower casing 212 to improve the color matching and to reduce the manufacturing cost of computer input device 100.

In some embodiments, upper casing 211 is made using a two-step insert or co-molding molding process. In these embodiments, substrate 316 is first made using an injection molding process. The second step of creating upper casing 211 involves forming overmold 315 using a second injection molding process and cooling overmold 315 on substrate 316. Lower casing 212 can also be formed using an injection molding process. Injection molding processes for creating plastic casings are well-known in the art and will not be described further herein.

Turning to the electronics inside of case 110, movement mechanism 230 can detect the movement of case 110. In the embodiment illustrated in FIGS. 1-7, movement mechanism 230 uses an optical sensor 231 to detect the movement of case 110. In other embodiments, other types of movement mechanisms can be used to detect the movement of case 110. For example, movement mechanism 230 can include laser or inertial mechanisms capable of detecting the movement of case 110.

Referring again to FIGS. 1-7, movement mechanism 230 can include: (a) sensor 231; (b) a light emitting diode (LED) 232; (c) a guide 233; (d) a lens seal frame 235 including a sensor lens 334; and (e) a lens seal 236. In some examples, sensor 231, LED 232, and guide 233 can be coupled to, or formed on a printed circuit board 239. In various embodiments, LED 232 emits light into guide 233, and this light is reflected out of case 110 though an aperture 338 in lower casing 212. A portion of the light is reflected off a surface 190 and back into sensor 231 through sensor lens 334. Sensor 231 uses the reflected light to calculate the movement of case 110.

In this embodiment, lens seal frame 235 can be coupled to lower casing 212 with lens seal 236 between lens seal frame 235 and lower casing 212. In some embodiments, the use of lens seal 236 creates a waterproof seal between lens seal frame 235 and lower casing 212. In other embodiments, an adhesive is used in addition to, or instead of, lens seal 236 to create the waterproof seal. In one example, lens seal frame 235 can be coupled to lower casing 212 using one or more screws 237.

In some embodiments, circuit board 239 can be coupled to lower casing 212. In one example, circuit board 239 is coupled to lower casing 212 by screwing screws 267 through circuit board 239 into screw receptacles 238.

In the embodiment illustrated in FIGS. 1-7, scrolling mechanism 220 uses a touchpad module 221 to provide scrolling capabilities. In same examples, touchpad module 221 is a capacitive touchpad module. In other embodiments, other types of scrolling mechanisms can be used to provide scrolling capabilities. Scrolling can be sliding a horizontal or vertical presentation of content, such as text, drawings, or images, across a screen in a computer monitor (not shown) attached to a computer (not shown). Scrolling is often used to show large amounts of data that cannot fit on the screen at the same time.

In some examples, the touchpad module 221 can be used create a zoom-in and zoom-out feature. In one example, a user uses the touchpad module 221 while simultaneously depressing a specific key on the computer keyboard, such as the Ctrl key, to replace the vertical scrolling function with a zoom-in and zoom-out feature.

Scrolling mechanism 220 is located inside of interior cavity 360 to allow computer input device 100 to be washable and easily cleaned. Another advantage of placing scrolling mechanism 220 completely inside of case 110 is that none of the parts of computer input device 100 can be removed. If parts of computer input device 100 were removable, these parts could easy be lost and also present a choking hazard for small children and pets. Furthermore, scrolling mechanism 220 could be jammed or clogged by foreign particles lodged in the portions of scrolling mechanism 220 outside of case 110, potentially interfering with the scroll function.

Scrolling mechanism 220 can include: (a) touchpad module 221; (b) a holder 222; (c) operations module 224; and (d) screws 223. In some embodiments, touchpad module 221 can include: (a) a sensor region 227; (b) a circuit board region 226 coupled to sensor region 227; and (c) a wire ribbon region 228 coupled to circuit board region 226. Touchpad module 221 is capable of detecting movement of a finger adjacent to sensor region 227.

In numerous examples, sensor region 227 is adjacent to inner surface 765 of portion 271. In some examples, sensor region 227 can be coupled to inner surface 765 using an adhesive. In some examples, touchpad module 221 is also held adjacent to inner surface 765 by screwing holder 222 to upper casing 211 using screws 223.

Sensor region 227 can register the movement of the user's finger on an external surface 299 of portion 272, and the electronics in circuit board region 226 can covert the movement detected in sensor region 227 into an electrical signal that can be communicated to operations module 224 through wires in wire ribbon region 228. The wires in wire ribbon region 228 can be coupled to operations module 224. Operations module 224 is configured to transfer the movement measured by touchpad module 221 to the attached computer through cable 140 and connector 241.

In the embodiment shown in FIGS. 1-7, buttons 250 include a right button 258 and a left button 259. End 251 of button 258 can be adjacent to a click module 256. Likewise, end 252 of button 259 can be adjacent to a click module 257. In other embodiments, buttons 250 could include one button, or three or more buttons. In some example, the number of buttons depends on the needs of the user and/or on the type of computer coupled to computer input device 100.

In many embodiments, buttons 258 and 259 can each include: (a) button region 281; and (b) a coupling region 282. When a user presses down on button 258 or 259 through portion 272, a button region 281 of the respective one of button 258 and 259 are depressed. Depressing button region 281 of buttons 258 or 259 will activate click module 256 or 257, respectively, and register the user action. The user action is converted into an electrical signal by click module 256 or 257 and communicated to the attached computer through cable 140 and connector 241. In other examples, buttons 250 can be part of the injection molded upper casing, where gaps between the buttons and the upper casing allow for deflection instead of mechanical fasteners.

In several embodiments, buttons 250 can be coupled to upper casing 211 using alignment pins 487 and screws 255. Screws 255 can be screwed through holes in coupling regions 282 into screw receptacles 488 in upper casing 211. In some examples, coupling regions 282 can also include one or more holes into which alignment pins 487 can be inserted to help align properly buttons 250 with portion 271.

While coupling region 282 is coupled to upper casing 211, a gap 485 exists between inner surface 313 and button region 281 of buttons 250. As an example, gap 485 can be comprised of air. In some examples, gap 485 helps prevent any accidental or inadvertent activation of click module 256 or 257. Moreover, in the same or different examples, gap 485 can help avoid cosmetic problems at the exterior surface of case 110. In some embodiments, case 110 is designed to have a smooth, mostly featureless surface (except for portion 271). If button regions 281 are touching or coupled to inner surface 313 of upper casing 211, outlines of the buttons could be seen on the exterior surface of case 110 and destroy the featureless look and feel of one embodiment of computer input device 100.

While having a gap 485 is useful, minimizing the width of gap 485 is preferable in some examples. Keeping gap 485 small helps decrease the push force necessary to activate click modules 256 and/or 257. In one example, the width of gap 485 is equal to or less than one-half of a millimeter.

In the same or different embodiments, connector 241 and cable 140 can be used to transmit electrical signals from computer input device 100 to an electrical device (e.g. a computer). In these embodiments, connector 241 can be coupled to end 242 of cable 140, and end 243 of cable 140 can be coupled to circuit board 239. Electrical signals indicating the user actions (e.g., click buttons 250, moving case 110, or using scrolling mechanism 220) can be commutated to the attached electrical device (e.g., a computer) through connector 241. In various embodiments, cable 140 is mechanically coupled to lower casing 212 using screws 244 and a clip 245. In some examples, a waterproof seal between cable 140 and case 110 is formed using a gasket and/or an adhesive.

In some example, connector 241 can be a standard connector, such as RS-232C (recommend standard 232C) connector, PS/2 (personal system/2) connector, ADB (Apple® desktop bus) connector, or USB (universal serial bus) connector. In other embodiments, connector 241 can be other standard or non-standard connectors. In some examples, connector 241 does not have to be washable or water-resistant for computer input device 100 to be washable or water-resistant.

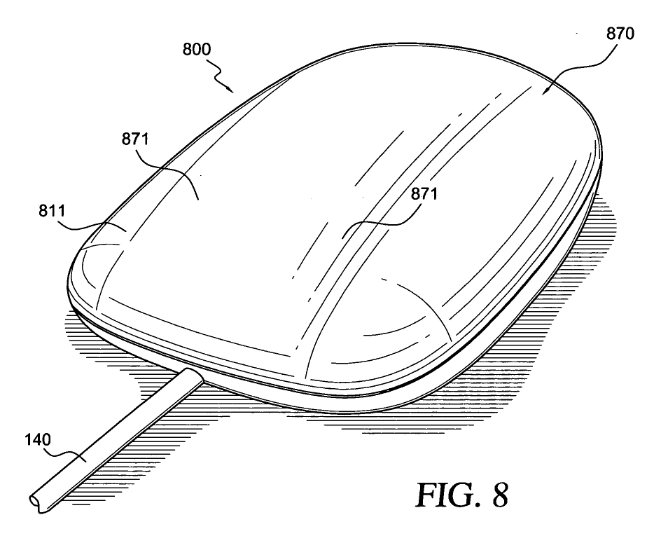

Turning to another embodiment, FIG. 8 illustrates a top, front, side isometric view of a computer input device 800, according to a second embodiment, and can be similar to computer input device 100 in FIG. 1, except as described below. In this embodiment, computer input device 800 does not include scrolling mechanism 220 (FIG. 2) or portion 271 (FIG. 2). In this example, upper casing 811 comprises: (a) portions 871; and (b) a portion 870. In some embodiments, portion 871 can include the region of upper casing 811 located above button regions (not shown) and can have a thickness less than the thickness of portion 870. The button region of computer input device 800 can be identical or substantially similar to button regions 281 of buttons 250 (FIG. 2). In some examples, portion 871 can be identical to or substantially similar to portion 271 (FIG. 2). Portion 870 can include the region of upper casing 811, not adjacent to the button regions. In this embodiment, a gap (not shown), identical or similar to gap 485 (FIG. 4), can exist between the button regions and portion 872.

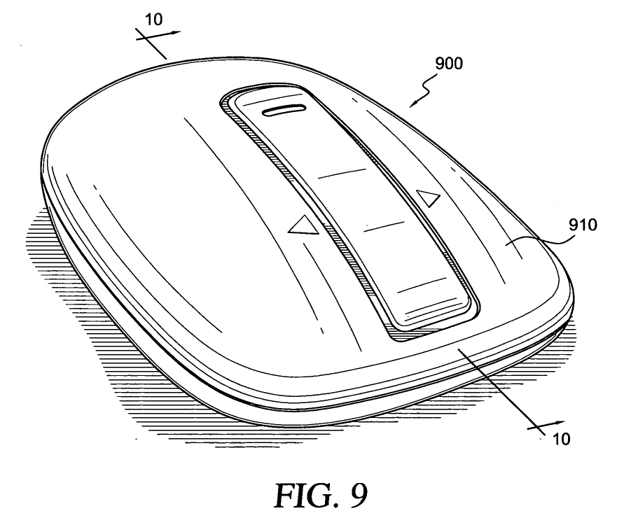

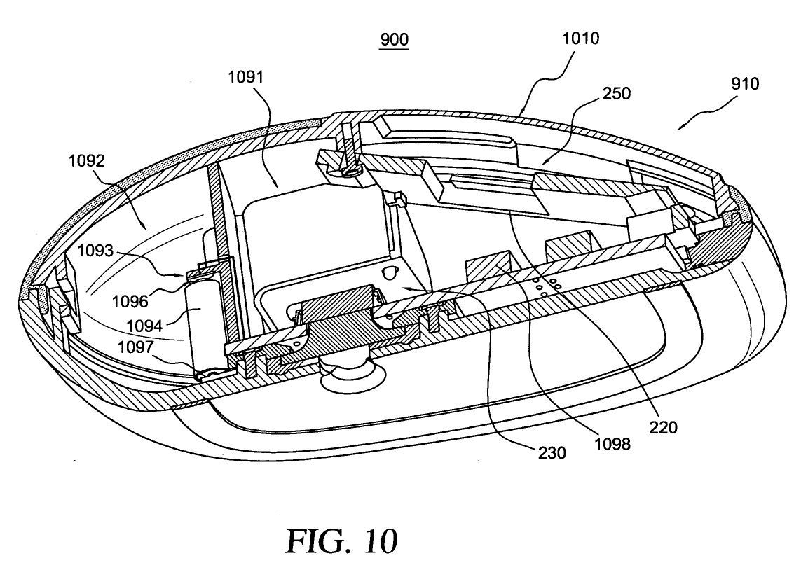

Turning to another embodiment, FIG. 9 illustrates a top, front, side isometric view of a computer input device 900, according to a third embodiment, and can be similar to computer input device 100, except as described below. FIG. 10 illustrates a cross-sectional view along line 10-10 (FIG. 9) of computer input device 900, according to the third embodiment. In this embodiment, computer input device 900 includes a wireless transmitter 1098 and at least one charging connector 1093. In some examples, computer input device 900 is washable and/or dishwasher safe. That is, computer input device 900 can be washed in a dishwashing machine without damaging computer input device 900.

In some embodiments, case 910 can include one or more compartments 1091 and 1092. In some examples, compartment 1091 can enclose scrolling mechanism 220, buttons 250, movement mechanism 230, and transmitter 1098. In various embodiments, compartment 1091 can be similar to interior cavity 360. Compartment 1092 can enclose a charging connector 1093 and, possibly, at least one removable electrical power source 1094. In one example, charging connector 1093 includes two terminals 1096 and 1097 that can be coupled to electrical power source 1094.

Electrical power source 1094 can be a disposable or rechargeable batter. The battery can provide electrical power to scrolling mechanism 220, buttons 250, movement mechanism 230, and transmitter 1098 inside compartment 1091. In one embodiment, the rechargeable battery can be charged using charging connector 1093 when computer input device 100 is not use. In an alternative example, charging connector 1093 can be a connector capable of being coupled to an electrical outlet or computer when a computer input device 900 is not in use. For example, the rechargeable battery can be recharged while remaining within compartment 1092 using inductive or capacitive power transfer technology known in the art. In some examples, a waterproof seal exists between compartments 1091 and 1092. In some embodiments, compartment 1092 can include a mechanism to remove and replace electrical power source 1094. For example, compartment 1092 can have a door (not shown) that can be opened to remove and replace electrical power source 1094. This door can then be closed such that case 910 is washable.

In the same or a different embodiment, transmitter 1098 in computer input device 900 is configured to communicate with a receiver (not shown) coupled to the computer. For example, the receiver can be a dongle coupled to a USB port on the computer.

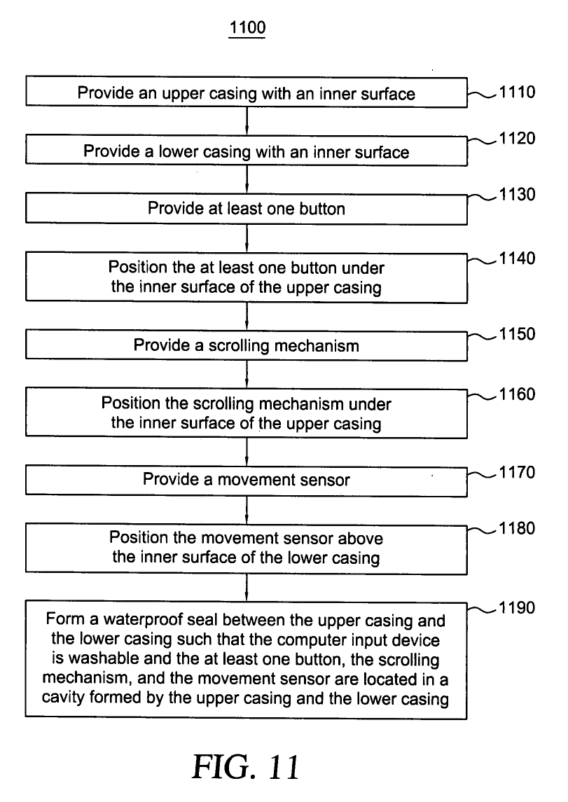

FIG. 11 illustrates a flow chart 1100 for a method of manufacturing a computer input device, according to an embodiment. In some examples, the computer input device can be identical to or similar to computer input devices 100, 800, or 900 of FIGS. 1 and 9, respectively.

Flow chart 1100 includes a step 1110 of providing an upper casing with an inner surface. As an example, the upper casing with an inner surface can be identical to or similar to upper casing 211 with inner surface 313 as shown in FIG. 3.

In some examples, step 1110 of providing the upper casing can include: (a) forming a substrate with an interior surface, the interior surface forming the inner surface of upper casing; and (b) forming an overmold at a portion of the substrate. For example, the substrate and the overmold can be identical to or similar to substrate 316 and overmold 315, respectively, of FIG. 3.

In the same or different example, step 1110 of providing the upper casing can include: (a) providing a first portion of the upper casing to have a first thickness; and (b) providing a second portion of the upper casing to have a second thickness. In some embodiments, the second thickness is less than the first thickness. For example, the first portion and the second portion can be identical to or similar to portions 270 and 271, respectively, of FIG. 2.

Flow chart 1100 of FIG. 11 continues with a step 1120 of providing a lower casing with an inner surface. In some examples, the lower casing with the inner surface can be identical to or similar to lower casing 212 with inner surface 214 of FIG. 2.

Subsequently, flow chart 1100 of FIG. 11 includes a step 1130 of providing at least one button. For example, the at least one button can be identical to or similar to buttons 250 of FIG. 2.

Next, flow chart 1100 of FIG. 11 includes a step 1140 of positioning the at least one button under the inner surface of the upper casing. In some examples, the positioning of the at least one button under the inner surface of the upper casing can be identical to or similar to the positioning of buttons 250 under inner surface 313 as shown in FIGS. 4 and 5.

Additionally, flow chart 1100 of FIG. 11 includes a step 1150 of providing a scrolling mechanism. In various examples, scrolling mechanism can be identical to or similar to scrolling mechanism 220 of FIG. 2.

Flow chart 1100 of FIG. 11 subsequently includes a step 1160 of positioning the scrolling mechanism under the inner surface of the upper casing. In some examples, the positioning of the scrolling mechanism under the inner surface of the upper casing can be identical to or similar to the positioning of scrolling mechanism 220 under inner surface 313 as shown in FIGS. 3, 4, and 5.

Moreover, flow chart 1100 of FIG. 11 includes a step 1170 of providing a movement sensor. In many examples, the movement sensor can be identical to or similar to movement sensor 231 as shown in FIG. 2.

Subsequently, flow chart 1100 of FIG. 11 includes a step 1180 of positioning the movement sensor above the inner surface of the lower casing. For example, positioning the movement sensor above the inner surface of the lower casing can be identical to or similar to the positioning of movement sensor 231 above inner surface 214 as shown in FIGS. 3, 4, and 5.

Flow chart 1100 of FIG. 11 continues with a step 1190 of forming a waterproof seal between the upper casing and the lower casing such that the computer input device is washable and where the at least one button, the scrolling mechanism, and the movement sensor are located in a cavity formed by the upper casing and the lower casing. In some examples, the waterproof seal between the upper casing and the lower casing can be identical to or similar to the waterproof seal between upper casing 211 and lower casing 212 shown in FIGS. 3, 4, and 5.

Although the invention has been described with reference to specific embodiments, it will be understood by those skilled in the art that various changes may be made without departing from the spirit or scope of the invention. For example, to one of ordinary skill in the art, it will be readily apparent other methods can be used to create the waterproof seal between upper casing 211 and lower casing 212 (FIG. 2). In another example, computer input device 100 (FIG. 1) does not include buttons 250 and portion 271 (FIG. 2). In this example, a person can tap on scrolling mechanism 220 (FIG. 2) to simulate clicking one of buttons 250. Furthermore, any of the computer input devices can be wired or wireless. Moreover, the sequence of the steps in flow chart 1100 can be rearranged such that, for example, steps 1170 and 1180 can occur before step 1130. Additional examples of such changes have been given in the foregoing description. Accordingly, the disclosure of embodiments of the invention is intended to be illustrative of the scope of the invention and is not intended to be limiting. It is intended that the scope of the invention shall be limited only to the extent required by the appended claims. To one of ordinary skill in the art, it will be readily apparent that the computer input device and method of manufacturing discussed herein may be implemented in a variety of embodiments, and that the foregoing discussion of certain of these embodiments does not necessarily represent a complete description of all possible embodiments. Rather, the detailed description of the drawings, and the drawings themselves, disclose at least one preferred embodiment of the invention, and may disclose alternative embodiments of the invention.

All elements claimed in any particular claim are essential to the invention claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A computer input device comprising:
an outer casing with an interior cavity;
a scrolling mechanism located within the interior cavity and useable through the outer casing;
one or more buttons located within the interior cavity and useable through the outer casing; and
a movement mechanism located within the interior cavity and configured to detect movement of the outer casing,
wherein:
the outer casing encloses the scrolling mechanism, the one or more buttons, and the movement sensor such that the computer input device is washable.

2. The computer input device of claim 1, wherein:
the outer casing comprises:
a first portion comprising a first material; and
a second portion comprising the first material and a second material different from the first material;
the scrolling mechanism is usable through the first portion; and
the first portion is devoid of the second material.

3. The computer input device of claim 2, wherein:
the outer casing further comprises:
a third portion comprising the second material and devoid of the first material.

4. The computer input device of claim 3, wherein:
the one or more buttons are usable through the third portion.

5. The computer input device of claim 2, wherein:
the second material is located over the first material in the second portion.

6. The computer input device of claim 1, wherein:
the movement mechanism comprises:
a sensor;
a sensor lens; and
a lens seal providing a waterproof seal between the sensor lens and the outer casing.

7. The computer input device of claim 6, wherein:
the outer casing has an aperture; and
the lens seal is adjacent to the aperture in the outer casing.

8. The computer input device of claim 1, wherein:
the scrolling mechanism comprises a capacitive touchpad module.

9. The computer input device of claim 1, wherein:
the movement sensor is an optical sensor.

10. The computer input device of claim 1, further comprising:
a cable with a first end and a second end, the first end of the cable is mechanically coupled to the outer casing with a waterproof seal; and
a connector coupled to the second end of the cable.

11. A mouse comprising:
a case comprising:
an upper casing with an inner surface; and
a lower casing with an inner surface and mechanically coupled to the upper casing to form a first waterproof seal;
at least one button located inside the case and adjacent to the inner surface of the upper casing; and
a movement sensor located inside the case and adjacent to the inner surface of the lower casing,
wherein:
the at least one button is accessible by a user through the upper casing; and
the at least one button is separated from the inner surface of the upper casing by a gap.

12. The mouse of claim 11, wherein:
the case is configured to protect the at least one button and the movement sensor at any angle from running water at a standard household water pressure.

13. The mouse of claim 11, further comprising:
a scrolling mechanism located inside the case and adjacent to the inner surface of the upper casing.

14. The computer input device of claim 11, wherein:
the upper casing comprises:
a substrate having a first surface and a second surface opposite the first surface; and
an overmold covering a first portion of the first surface of the substrate; and
the second surface of the substrate is the inner surface of the upper casing.

15. The computer input device of claim 14, further comprising:
a scrolling mechanism,
wherein:
a second portion of the substrate is not covered by the overmold; and
the scrolling mechanism is located adjacent to the second portion of the substrate and usable by the user through the second portion of the substrate.

16. The computer input device of claim 14, wherein:
the at least one button is located adjacent to the first portion of the substrate.

17. The computer input device of claim 11, wherein:
the upper casing comprises:
a first section with a first thickness; and
a second section with a second thickness;
the first thickness is less than the second thickness; and
the at least one button is located adjacent to the inner surface of the first section of the upper casing.

18. The computer input device of claim 17, further comprising:
a scrolling mechanism,
wherein:
the upper casing further comprises:
a third section with a third thickness;
the third thickness is less than the first thickness and the second thickness; and
the scrolling mechanism is located adjacent to the inner surface of the third section of the upper casing.

19. The computer input device of claim 11, wherein:
the first waterproof seal comprises one or more screws and a gasket.

20. A method of manufacturing a computer input device comprising:
providing an upper casing with an inner surface;
proving a lower casing with an inner surface;
providing at least one button;
positioning the at least one button under the inner surface of the upper casing;
providing a scrolling mechanism;
positioning the scrolling mechanism under the inner surface of the upper casing;
providing a movement sensor;
positioning the movement sensor above the inner surface of the lower casing; and
forming a waterproof seal between the upper casing and the lower casing such that the computer input device is washable and the at least one button, the scrolling mechanism, and the movement sensor are located in a cavity formed by the upper casing and the lower casing.

21. The method of claim 20, wherein:
providing the upper casing comprises:
forming a substrate with an interior surface, the interior surface forming the inner surface of upper casing; and
forming an overmold over a portion of the substrate.

22. The method of claim 20, wherein:
providing the upper casing further comprises:
providing a first portion of the upper casing to have a first thickness; and
providing a second portion of the upper casing to have a second thickness;
the second thickness is less than the first thickness; and
positioning the at least one button further comprises:
positioning the at least one button adjacent to the second portion of the upper casing.

23. The method of claim 20, wherein:
positioning the at least one button comprises:
positioning the at least one button under the inner surface of the upper casing such that a gap exists between a portion of the at least one button and the upper casing.

24. A computer mouse comprising:
a case having an internal space, the case comprises:
a first portion with a first thickness; and
a second portion with a second thickness less than the first thickness;
a touchpad located within internal space and useable through the case;
at least one button located within the internal space and useable through the case; and
a movement mechanism located within the internal space and configured to detect movement of the case, the movement mechanism comprises:
a sensor;
a sensor lens; and
a lens seal providing a waterproof seal between the sensor lens and the case,
wherein:
the case protects the touchpad, the at least one button, and the movement sensor from running water at any angle and at a standard household water pressure;
the at least one button is located adjacent to the first portion of the case; and
the touchpad is located adjacent to the second portion of the case.
